(19) United States
(12) Patent Application Publication
(10) Pub. No.: US 2013/0096782 A1
(43) Pub. Date: Apr. 18, 2013

(54) Control Method for a Pivoting Grain Unloading Spout for Use with Combine Harvesters

(71) Applicants: Grant Lewis Good, Moundridge, KS (US); Gerald Ray Johnson, Hesston, KS (US)

(72) Inventors: Grant Lewis Good, Moundridge, KS (US); Gerald Ray Johnson, Hesston, KS (US)

(73) Assignee: AGCO CORPORATION, Duluth, GA (US)

(21) Appl. No.: 13/272,756

(22) Filed: Oct. 13, 2011

(51) Int. Cl. A01D 41/127; B65G 33/24; G06F 19/00; B65G 33/08

(52) U.S. Cl. 701/50; 198/617; 414/809

(57) ABSTRACT

In one embodiment, a method for controlling a pivoting auger spout of an auger tube from an operator console in a cab of a combine harvester, the auger tube at least partially encompassing an auger, the method comprising receiving a first signal corresponding to user activation of a first interface element of the operator console to a first state; and if the auger is engaged, causing the pivoting auger spout to pivot about a first axis responsive to receiving the first signal, otherwise, if the auger is disengaged, causing the auger tube to swing toward a first position responsive to the first signal.

### TECHNICAL FIELD

The present disclosure is generally related to combine harvesters and, more particularly, is related to crop dispensing mechanisms from a combine harvester.

### BACKGROUND

Combine harvesters harvest crop and then unload the harvested crop, such as grain, from storage bins residing on the combine harvester to the bed of a receiving vehicle, such as a truck bed. A common mechanism for performing this function is by way of an auger discharging the grain from the storage bins through an auger tube that encompasses the auger. Pivoting grain unloading spouts (herein, also referred to as pivoting auger spouts) are available today for use with combine harvesters, and are generally located at the distal end of the auger tube. Such pivoting auger spouts allow operators to more finely control the placement of grain as it flows out of the auger, as well as serve as a grain spill saver when the unloading clutch is switched off. Unfortunately, the control method for these pivoting auger spouts is generally quite cumbersome.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram showing a rear end view of a combine harvester showing grain unloading from an auger tube into a truck, the auger tube coupled to a pivoting auger spout.

FIG. 1B is a schematic diagram showing a partial cut-away view of a portion of the auger tube revealing an auger contained therein.

FIG. 2 is a schematic diagram showing a left side elevation of the rear end of the combine harvester showing the auger tube in longitudinal relationship to the combine harvester with the pivoting auger spout in a home position.

FIG. 3 is a schematic diagram showing a perspective view of an example embodiment of an operator console including an auger engagement/disengagement button and a swing in and swing out button on a joystick of the operator console.

FIG. 4 is a flow diagram that illustrates an embodiment of a pivoting auger spout control system using the engagement/disengagement button and the swing in and swing out button on the joystick of the operator console.

FIG. 5 is a block diagram that illustrates an embodiment of an example pivoting auger spout control system.

FIG. 6 is a flow diagram that illustrates an embodiment of a method for controlling a pivoting auger spout.

### DESCRIPTION OF EXAMPLE EMBODIMENTS

### Overview

In one embodiment, a method for controlling a pivoting auger spout of an auger tube from an operator console in a cab of a combine harvester, the auger tube at least partially encompassing an auger, the method comprising receiving a first signal corresponding to user activation of a first interface element of the operator console to a first state; and if the auger is engaged, causing the pivoting auger spout to pivot about a first axis responsive to receiving the first signal, otherwise, if the auger is disengaged, causing the auger tube to swing toward a first position responsive to the first signal.

### DETAILED DESCRIPTION

Certain embodiments of a pivoting auger spout control system for a combine harvester are disclosed that provides a simple control method for a pivoting grain unloading spout that requires no additional buttons, levers, pedals, etc. other than those presently existing to control a grain unloading auger. Previous control methods for pivoting the unloading auger spout have required additional manual-input controls, beyond the standard unloading auger controls, to be used by the operator. In contrast, one or more embodiments of a pivoting auger spout control system incorporate an operator control for the swiveling unloading auger spout into the existing set of controls that the operator is accustomed to utilizing to control the unloading auger. Some benefits of the pivoting auger spout control system include, among others, keeping the number of controls (also, referred to herein as interface elements) an operator uses to a minimum level, and allowing the controls for the pivoting unloading auger spout to be in a position that the operator is familiar with using on a regular basis. For instance, in one embodiment, the integration of this control to the unloading auger swing in and swing out control helps to make the control of the spout's position more intuitive to the operator.

Having summarized certain features of a pivoting auger spout control system of the present disclosure, reference will now be made in detail to the description of the disclosure as illustrated in the drawings. While the disclosure is described in connection with these drawings, there is no intent to limit it to the embodiment or embodiments disclosed herein. Further, although the description identifies or describes specifics of one or more embodiments, such specifics are not necessarily part of every embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

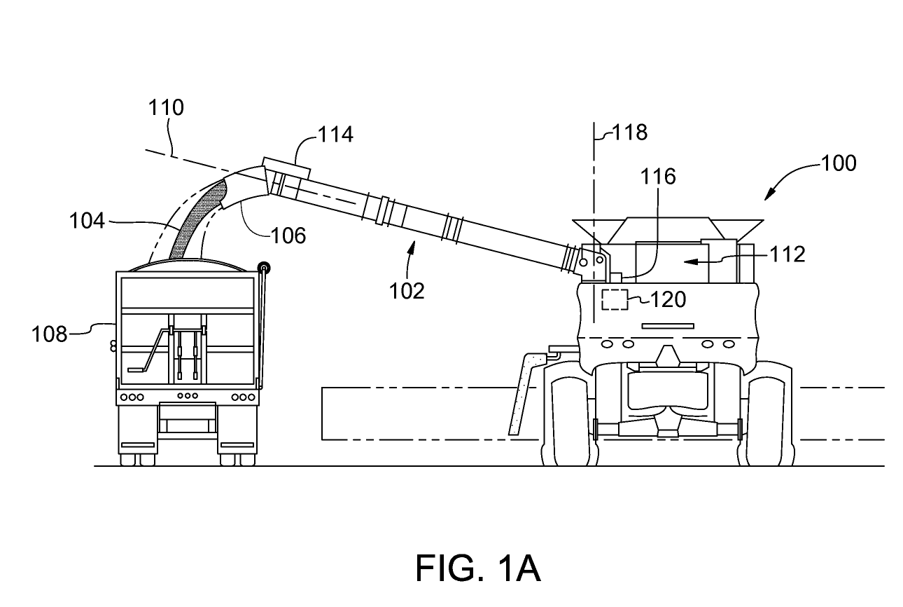

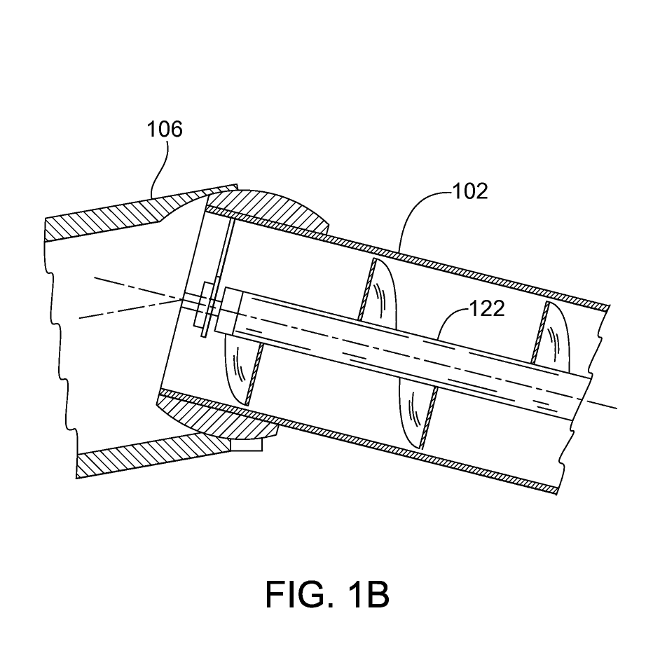

Referring now to FIG. 1A, a combine harvester 100 is shown in rear end view with its unloading auger tube 102 (herein, also referred to as simply an auger tube) transversely extending and fully deployed as it unloads harvested crop, such as grain 104, through a pivoting auger spout 106 into a bed of a vehicle, such as a truck 108. One having ordinary skill in the art should appreciate in the context of the present disclosure that the combine harvester 100 and associated components are merely illustrative, and that other configurations and arrangement of components may be used in some embodiments. The pivoting auger spout 106 may be cylindrical or angled in structure (e.g., rectangle, conical, etc.). The opening of the auger tube 102 at its distal end is peripherally sealed by a joint member that hingedly engages the pivoting auger spout 106 to interface the spout 106 to the distal end of the auger tube 102. The joint member may be rounded or spherical, or cylindrical on a horizontal axis, so long as the interface between the auger tube 102 and pivoting auger spout 106 is adequately sealed. In one embodiment, the pivoting auger spout 106 pivots about an axis 110 (e.g., backward and forward in the direction of travel of the combine harvester 100 in FIG. 1A when the tube 102 is extended transversely) of the auger tube 102. In some embodiments, the pivoting auger spout 106 pivots about an axis perpendicular to axis 110 (e.g., up and down) relative to the auger tube 102, or in some embodiments, a combination of these or other pivoting movements.

Signals from a cab 112 of the combine harvester 100 travel through one or more wires for controlling plural devices 114 and 116. For instance, devices 114 and 116 may be actuators (e.g., electrical, pneumatic, or hydraulic) that couple to the pivoting auger spout 106 and auger tube 102, respectively, to control (e.g., cause) movement of the respective pivoting auger spout 106 (e.g., pivoting movement about axis 110) and auger tube 102 (swing movement about axis 118). In other words, the cab 112 includes an operator console that in one embodiment makes up at least a portion of a pivoting auger spout control system, the console comprising operator controls (e.g., interface elements, such as buttons, levers, etc.) enabling an operator to control movement of the pivoting auger spout 106 and the auger tube 102.

In one embodiment, as noted above, movement of the pivoting auger spout 106 is about the axis 110 of the auger tube 102. For instance, in an unloading position, the opening of the pivoting auger spout 106 enables grain to spill directly (or substantially so) downward to the bed of the truck 108. This position may be a default position responsive to engagement of an auger clutch (not shown), which may be actuated from cab signals via a device (e.g., actuator) 120. In other words, the device 120 receives signals from the cab 112 that either causes engagement or disengagement (e.g., shut-off) of the auger clutch with an auger contained in the auger tube 102. In some embodiments, a different default position than the one described above may be used, including positions that enable release of grain at an angle other than straight down. The pivoting action of the pivoting auger spout 106 enables the grain to be evenly distributed along the truck bed. In other words, the pivoting auger spout 106 may release grain forward and backward from the default position, among other pivoting movements in some embodiments as indicated above.

A grain saver position, otherwise referred to herein as a home position, refers to a pivot position of the pivoting auger spout 106 that prevents or hinders the release of grain from the pivoting auger spout 106. In one embodiment, the home position may correspond to a position 90° from the default position. In other words, when the auger tube 102 is extended out from the combine harvester 100, the opening of the pivoting auger spout 106 may face directly back (or directly forward in some embodiments) in the longitudinal direction of the combine harvester 100. In other words, at least in one embodiment, the home position corresponds to a given angular position about the axis 110 of the auger tube 102, and this home position functions as a spill saver to prevent grain loss after the auger is turned off. When the combine harvester 100 is not actively unloading grain 104, the pivoting auger spout 106 returns to its home position. In some embodiments, the home position may correspond to a position at another angle relative to the default position, such as 120°, 180°, etc. The prevention of inadvertent grain spillage and/or suitability in maintaining a low-profile in the home position relative to the combine harvester 100 is a few of the considerations in choosing a desired home position. It should be appreciated that one having ordinary skill in the art may select one of a plurality of different pivoting ranges to suit the design needs.

FIG. 1B is a schematic showing a partial cut-away view of a portion of the auger tube 102 near a connection of the pivoting auger spout 106 (also shown partially). One having ordinary skill in the art should appreciate in the context of the present disclosure that the auger tube 102 and associated components are merely illustrative, and that other configurations and arrangement of components may be used in some embodiments. As depicted in FIG. 1B, the auger tube 102 encompasses (at least partially) an auger 122 that transports the grain 104 from one or more grain bins (not shown) of the combine harvester 100. The grain 104 passes through the pivoting auger spout 106 and is released to the truck bed.

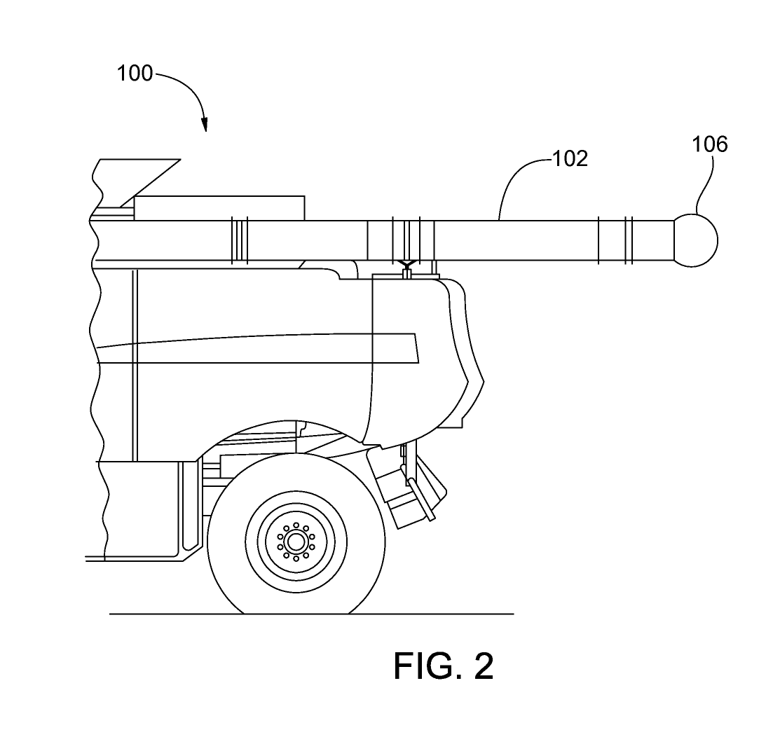

Attention is now directed to FIG. 2, where the auger 122 has been disengaged (e.g., shut off) and the auger tube 102 has been moved to its storage (e.g., rest) position, longitudinally parallel to the length and direction of the combine harvester 100. Also, the pivoting auger spout 106 has been positioned to its home position (in this example, the opening of the spout 106 is directed along an axis that is transverse to the direction of travel of the combine harvester 100, rotated 90° in this example from the default unloading position), preventing spillage of the grain 104.

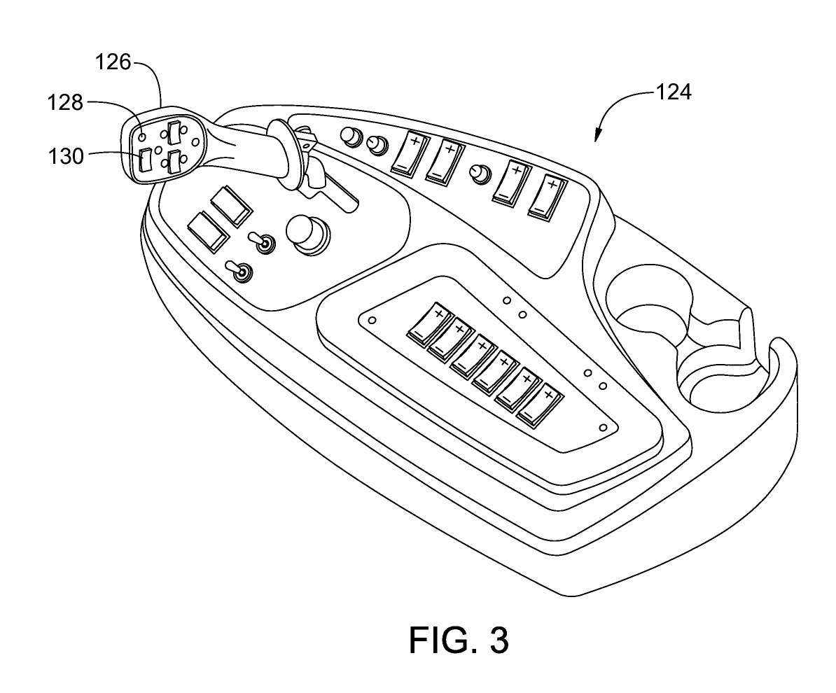

Having described an example environment in which certain embodiments of a pivoting auger spout control system may be implemented, reference is made to FIG. 3, which is a schematic diagram illustrating an example operator console 124. One having ordinary skill in the art should appreciate in the context of the present disclosure that the operator console 124 is merely illustrative, and that other consoles may be used in some embodiments, including a different arrangement of buttons and levers, a replacement of the joystick with other like-functioned mechanisms, etc. Further, though the operator console 124 comprises many features, attention is directed to a subset of those features more relevant to certain embodiments of a pivoting auger spout control system. For instance, the operator console 124 comprises a joystick 126 with interface elements 128 and 130 residing thereon. The interface element 128 (also, engagement/disengagement button) comprises a push-button that an operator selects to cause engagement or disengagement of the auger 122 with the auger clutch. Though shown as a button, other mechanisms of selection/switching (e.g., levers, toggle switches, rocker switches, etc.) may be employed in some embodiments.

The interface element 130 comprises a multi-state switch that performs different functions depending on whether the upper portion of the interface element 130 is selected by the operator or the lower portion of the interface element 130 is selected. In one embodiment, the interface element 130 comprises a swing in and swing out button as found (with less functionality) in many existing combine harvesters 100 for certain manufacturers, hence providing an operator control and associated position that is familiar to many operators, and avoiding the need for additional controls in the operator console 124. By selecting the interface element 130, the operator may cause both pivotal movement of the pivoting auger spout 106 and swing movement of the auger tube 102, as explained further below. Similar to the interface element 128, other configurations for selection/switching may be used in place of the button as shown for the interface element 130 in some embodiments. Further, though shown residing on the joystick 126, the interface elements 128 and/or 130 may be positioned on other portions of operator consoles for other manufactures, and the positions of those elements are also contemplated to be within the scope of the disclosure.

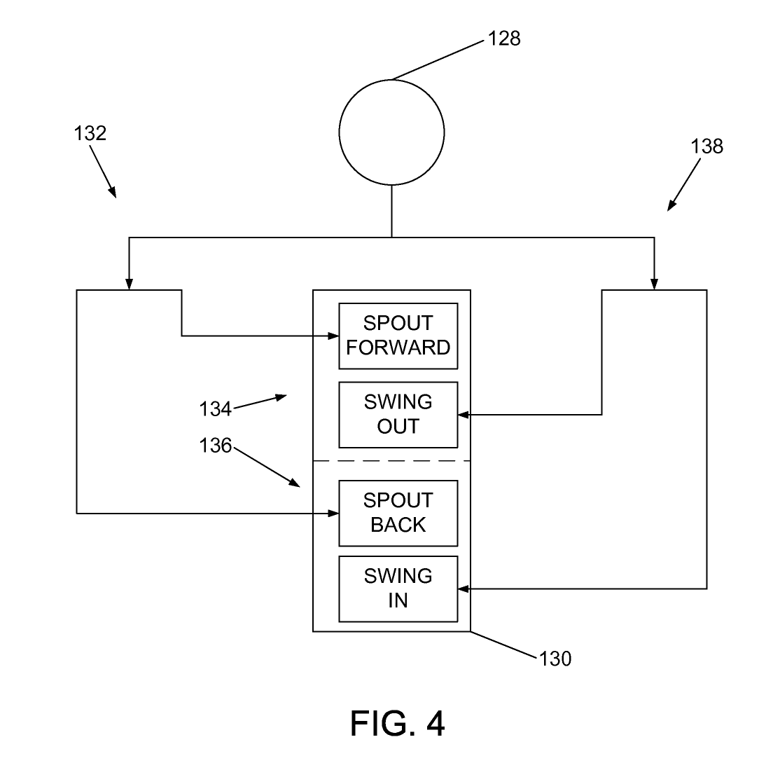

An example operation of an embodiment of a pivoting auger spout control system through operator interaction with the operator console 124 is illustrated in FIG. 4. In particular, FIG. 4 is a flow diagram that shows how an embodiment of a pivoting auger spout control system enables multiple functions (and states) to be achieved through interface elements 128, 130 of the operator console 124. When the interface element 128 is selected to cause engagement of the auger 122 (e.g., with the auger clutch), the engage branch 132 of the auger spout control system logic is activated. In the engage branch 132, the operator may select the upper portion 134 of the interface element 130 to cause the pivoting auger spout 106 to pivot about the axis 110 (e.g., to pivot forward toward the direction of travel of the combine harvester 100), such as to cause the grain 104 to be released to one area of a truck bed to more evenly distribute the grain load that is being transported by the auger 122. The operator may alternatively select the lower portion 136 (delineated in FIG. 4 by the dashed line located between the portions 134 and 136) of the interface element 130 to cause the pivoting auger spout 106 to pivot about the axis 110 in a different direction (e.g., to pivot backward along the axis of travel of the combine harvester 100), such as to cause the grain 104 to be released to another area of a truck bed to more evenly distribute the grain load. Thus, in the engage branch 132, the operator can toggle the interface element 130 according to different states to cause the pivoting auger spout 106 to pivot in different directions.

When the interface element 128 is selected to cause disengagement of the auger 122 (e.g., from engagement with the auger clutch), the disengage branch 138 of the auger spout control system logic is activated. In the disengage branch 138, the operator may select the upper portion 134 of the interface element 130 to cause the auger tube 102 to pivot about the axis 118 (e.g., to swing out, away from the combine harvester 100), such as to position the auger tube 102 to unload the grain 104 from the combine harvester 100 to the truck 108. The operator may alternatively select the lower portion 136 of the interface element 130 to cause the auger tube 102 to pivot about the axis 118 in a different direction (e.g., to cause the auger tube 102 to swing back toward the combine harvester 100), such as to return the auger tube 102 to its rest position alongside the combine harvester 100.

Having described the operator console 124, auger tube 102, and pivoting auger spout 106, an example operation is described below. When the operator causes the auger tube 102 to swing out and further causes engagement of the auger 122 (with the auger clutch) to commence unloading of the grain 104, the pivoting auger spout 106 automatically pivots to a default unloading position (e.g., directly downward at the bottom center of the auger tube 102, though not limited to directly downward), hence releasing the grain to the truck 108. Once the auger clutch is engaged with the auger 122 and the grain 104 is in the process of unloading, the interface element 130 for controlling the auger tube 102 swinging movement transitions to controlling the angular position of the pivoting auger spout 106 about the axis 110 of the auger tube 102. Activation by the operator (e.g., pressing, such as pressing the upper portion 134) of the interface element 130 (e.g., the swing in and swing out button, which in this branch 132 provides the spout back, spout forward function) causes pivoting of the pivoting auger spout 106 in one direction, and pressing the interface element 130 (e.g., the lower portion 136) causes the pivoting to occur in another direction.

Note that advancement of the pivoting auger spout 106 (or auger tube 102) in one direction or the other may occur in one embodiment by repeatedly pressing the interface element 130 (e.g., repeatedly pressing the upper portion 134 or lower portion 136). In some embodiments, the continued advancement in one direction or the other may be achieved by holding down the interface element (e.g., sustained pressing of the upper portion 134 or lower portion 136), and in some embodiments, a single, quick press and release may cause a defined rotation (e.g., full or partial).

Once the auger clutch and auger 122 are disengaged, and the grain 104 is no longer unloading from the combine harvester 100 to the truck 108, the pivoting auger spout 106 automatically returns to its home position, and the interface element 130 for controlling auger swing movement returns to its base (e.g., normal) functionality.

Note that variations in the process above are contemplated to be within the scope of the disclosure. For instance, some embodiments of the pivoting auger spout control system may employ a time delay to move to or from the home position upon a status change of the unloading auger clutch, and/or some embodiments may use preset angular positions (rather than infinite angular control) within the usable range of motion.

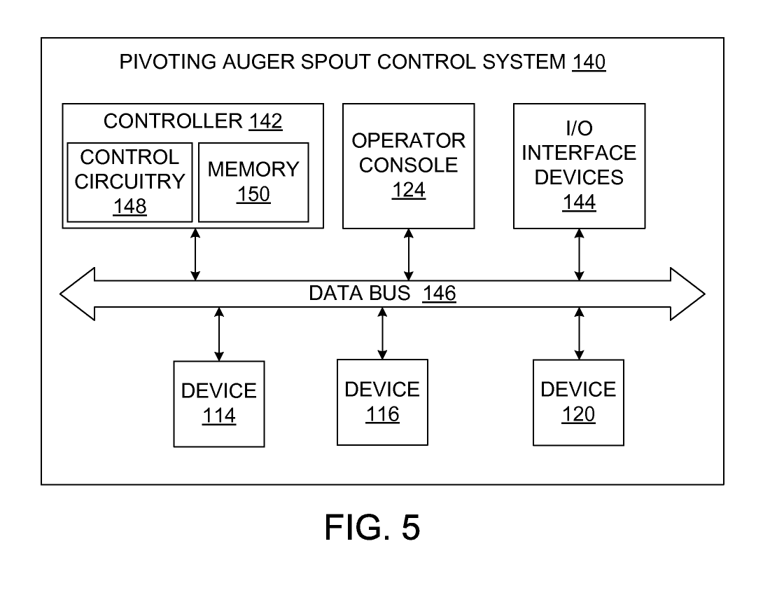

Attention is now directed to FIG. 5, which illustrates an example embodiment of a pivoting auger spout control system 140. One having ordinary skill in the art should appreciate in the context of the present disclosure that the pivoting auger spout control system 140 is merely illustrative, and that other architectures and manners of electronic control may be used in some embodiments. The pivoting auger spout control system 140 comprises a controller 142, the operator console 124, input/output (I/O) interface devices 144, and devices 114, 116, and 120, all coupled to one or more data busses, such as data bus 146. The controller 142 may comprise control circuitry 148, which may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the combine harvester 100.

The controller 142 further comprises memory 150. The memory 150 may include any one of a combination of volatile memory elements (e.g., random-access memory RAM, such as DRAM, and SRAM, etc.) and nonvolatile memory elements (e.g., ROM, hard drive, tape, CDROM, etc.). The memory 150 may store a native operating system, one or more native applications, emulation systems, or emulated applications for any of a variety of operating systems and/or emulated hardware platforms, emulated operating systems, etc. For example, in some embodiments, control of the devices 114, 116, and 120 may be implemented through software or firmware (e.g., executable instructions) executing on a processor of the control circuitry 148. In some embodiments, the memory 150 may be separate (e.g., a distinct component) from the controller 142, and in some embodiments, such as where control of the devices 114, 116, and 120 is performed purely in hardware, memory 150 may be omitted.

The operator console 124 comprises a plurality of operator controls, including the joystick 126 and interface elements 128, 130, which upon activation, are used to determine the signaling or control path (e.g., engage branch 132, disengage branch 138) of the controller 142 and associated functionality.

The I/O interface devices 144 comprise any number of interfaces for the input and output of data, such as locally or via a network to a remote location. As a non-limiting example, when including a network interface, such an I/O interface device 144 may include a modulator/demodulator (e.g., a modem), wireless (e.g., radio frequency (RF)) transceiver, a telephonic interface, among other network components.

The devices 114, 116, and 120, as indicated above, include mechanical and/or electrical actuators that enable translation (e.g., transduction) of signals from the controller 142 to a mechanical output, such as auger clutch engagement with the auger 122, swing movement about axis 118 of the auger tube 102, and pivoting about axis 110 of the pivoting auger spout 106. In some embodiments, intermediary controllers or devices may be used.

It should be appreciated that other devices may be employed in the operation and/or control of the combine harvester 100 that are not shown for brevity, including global positioning devices (e.g., GPS devices), display devices, among other components.

Where the controller 142 is implemented at least in part in logic configured as software/firmware (e.g., generally, an application), it should be noted that the application can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program for use by or in connection with a computer-related system or method. The application may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

Where the controller 142 is implemented at least in part in logic configured as hardware, the controller 142 may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The controller 142 is implemented using hardware, software, or a combination of hardware and software.

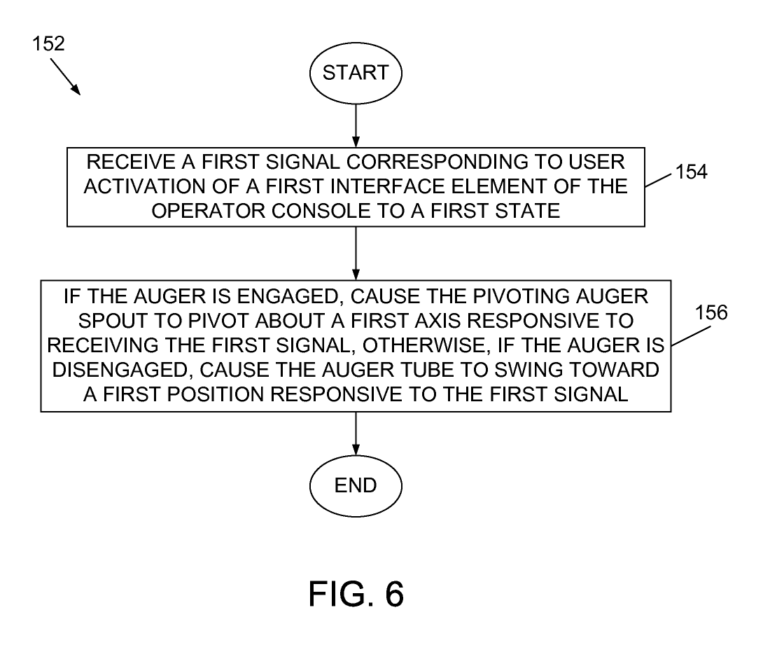

Having described some example embodiments of a pivoting auger spout control system 140, it should be appreciated in view of the present disclosure that one embodiment of a method for controlling a pivoting auger spout, the method depicted in FIG. 6 and denoted as method 152, comprises receiving a first signal corresponding to user activation of a first interface element of the operator console to a first state (154); and if the auger is engaged, causing the pivoting auger spout to pivot about a first axis responsive to receiving the first signal, otherwise, if the auger is disengaged, causing the auger tube to swing toward a first position responsive to the first signal (156).

Any process descriptions or blocks in flow charts should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

1. A method for controlling a pivoting auger spout of an auger tube from an operator console in a cab of a combine harvester, the auger tube at least partially encompassing an auger, the method comprising:
receiving a first signal corresponding to user activation of a first interface element of the operator console to a first state; and
if the auger is engaged, causing the pivoting auger spout to pivot about a first axis responsive to receiving the first signal, otherwise, if the auger is disengaged, causing the auger tube to swing toward a first position responsive to the first signal.

2. The method of claim 1, wherein auger engagement and disengagement is responsive to selection of a second interface element of the operator console.

3. The method of claim 1, wherein the first interface element comprises a swing in and swing out button.

4. The method of claim 1, wherein causing the pivoting auger spout to pivot about the first axis comprises pivoting about the axis of the auger tube.

5. The method of claim 1, wherein causing the pivoting auger spout to pivot about the first axis comprises actuating a hydraulic, pneumatic, or electric device that causes the pivoting about the axis of auger tube.

6. The method of claim 1, wherein causing the auger tube to swing toward the first position comprises causing the auger tube to swing toward the combine harvester.

7. The method of claim 6, wherein the pivoting auger spout automatically pivots to a home position at a time corresponding to disengagement of the auger tube, the home position hindering release of grain from the pivoting auger spout.

8. The method of claim 1, wherein causing the auger tube to swing toward the first position comprises actuating a hydraulic, pneumatic, or electric device that causes the swing toward the first position.

9. The method of claim 1, further comprising:
receiving a second signal corresponding to user activation of the first interface element of the operator console to a second state different than the first state; and
if the auger is engaged, causing the pivoting auger spout to pivot about the first axis responsive to receiving the second signal, otherwise, if the auger is disengaged, causing the auger tube to be positioned to an unloading position responsive to the second signal.

10. The method of claim 9, further comprising causing the pivoting auger spout to pivot at a time corresponding to completion of the positioning to the unloading position and engagement of the auger subsequent to the completion of the positioning, the unloading position corresponding to a bottom and center position of the auger tube, the pivoting of the spout, at the time corresponding to completion of the position and the engagement of the auger, enabling release of grain from the auger tube to a vehicle bed.

11. A pivoting auger spout control system for a combine harvester, the pivoting auger spout control system comprising:
an operator console residing in a cab of the combine harvester, the operator console comprising an interface element;
a controller coupled to the interface element; and
plural devices coupled to the controller and to an auger, an auger tube containing the auger, and a pivoting auger spout coupled to the auger tube,
wherein the controller is configured to receive a first signal corresponding to user activation of the interface element, wherein if the auger is engaged, the controller is further configured to cause the pivoting auger spout to pivot about a first axis responsive to receiving the first signal, otherwise, if the auger is disengaged, the controller is further configured to cause the auger tube to swing about a second axis responsive to the first signal.

12. The pivoting auger spout control system of claim 11, wherein the operator console further comprise a second interface element configured to cause auger engagement and disengagement responsive to selection by the operator.

13. The pivoting auger spout control system of claim 11, wherein the controller is configured to cause the pivoting auger spout to pivot about the first axis by causing pivoting about the axis of the auger tube.

14. The pivoting auger spout control system of claim 11, wherein the controller is configured to cause the pivoting auger spout to pivot about the first axis by actuating one of the plural devices, the one of the plural devices comprising a hydraulic, pneumatic, or electric device that causes the pivoting about the axis of auger tube.

15. The pivoting auger spout control system of claim 11, wherein the controller is configured to cause the auger tube to swing about the second axis by causing the auger tube to swing toward the combine harvester.

16. The pivoting auger spout control system of claim 15, wherein the pivoting auger spout automatically pivots to a home position at a time corresponding to commencement of disengagement of the auger tube to cease release of the grain, the home position hindering release of grain from the pivoting auger spout.

17. The pivoting auger spout control system of claim 11, wherein the controller is configured to cause the auger tube to swing about the second axis by actuating one of the plural devices, the one of the plural devices comprising a hydraulic, pneumatic, or electric device that causes the swing about the second axis.

18. The pivoting auger spout control system of claim 11, wherein the controller is further configured to cause the pivoting auger spout to pivot at a time corresponding to completion of positioning the auger tube to an unloading position and engagement of the auger subsequent to the completion of the positioning, the unloading position corresponding to a bottom and center position of the auger tube, the pivoting of the spout, at the time corresponding to completion of the position and the engagement of the auger, enabling release of grain from the auger tube to a vehicle bed.

19. A pivoting auger spout control system for a combine harvester that comprises an auger tube at least partially encompassing an auger and that is coupled to a pivoting auger spout, the pivoting auger spout control system comprising:
a controller configured to receive a first signal corresponding to user activation of an interface element of an operator console to a first state, wherein if the auger is engaged, the controller is further configured to actuate a first device to cause the pivoting auger spout to pivot about an axis of the auger tube in a first direction responsive to receiving the first signal, otherwise, if the auger is disengaged, the controller is further configured to actuate a second device to cause the auger tube to swing about a second axis in a second direction responsive to the first signal.

20. The pivoting auger spout control system of claim 19, wherein the controller is further configured to receive a second signal corresponding to user activation of the interface element of the operator console to a second state different than the first state, wherein if the auger is engaged, the controller is further configured to actuate the first device to cause the pivoting auger spout to pivot about the axis of the auger tube in a second direction responsive to receiving the second signal, otherwise, if the auger is disengaged, the controller is further configured to actuate the second device to cause the auger tube to swing about the second axis in a direction different than the second direction responsive to the second signal.

21. The pivoting auger spout control system of claim 19, wherein the controller is further configured to actuate using a delayed control or incremental control.
